(19) United States
(12) Patent Application Publication
(10) Pub. No.: US 2025/0251637 A1
(43) Pub. Date: Aug. 7, 2025

(54) ELECTROPHORETIC DISPLAY WITH CHARGE BALANCE ENHANCING CIRCUIT

(71) Applicant: SUPERC-TOUCH CORPORATION, New Taipei City (TW)

(72) Inventors: Hsiang-Yu LEE, New Taipei City (TW); Shang CHIN, New Taipei City (TW); Ping-Tsun LIN, New Taipei City (TW); Chia-Cheng LEI, New Taipei City (TW); Kun-Yu CHEN, New Taipei City (TW)

(21) Appl. No.: 19/030,836

(22) Filed: Jan. 17, 2025

(30) Foreign Application Priority Data
Feb. 2, 2024 (TW) 113104205

(51) Int. Cl. G02F 1/16755; G02F 1/167; G02F 1/16757

(52) U.S. Cl. CPC G02F 1/16755; G02F 1/167; G02F 1/16757

(57) ABSTRACT

An electrophoretic display with charge balance enhancing circuit includes a control substrate, a charge balance substrate, a charge balance electrode, a display layer arranged on one side of the control substrate, and a charge balance enhancing circuit. The electrophoretic display further includes a plurality of pixel electrodes, a plurality of capacitance electrodes and a plurality of storage capacitors. One end of the storage capacitor is the capacitance electrode. The charge balance enhancing circuit includes a charge-voltage conversion capacitor having a first terminal and a second terminal. The second electrode of the storage capacitor is electrically connected to the first terminal of the charge-voltage conversion capacitor, and the charge balance electrode is electrically connected to the second terminal of the charge-voltage conversion capacitor.

### BACKGROUND

### Technical Field

The present invention relates to an electrophoretic display, especially to an electrophoretic display with charge balance enhancing circuit.

### Description Of Related Art

The electronic paper displays, such as electrophoretic displays (EPD) have the advantages of lightweight and low energy consumption. In addition, electronic paper can retain images even after power off. Therefore, the electronic paper displays have been used in e-readers, mobile phones, and wearable device applications. Besides, the electronic paper displays are also used in shelf labels in supermarkets and instant message boards at bus stops, to achieve the goal of energy conservation and sustainability.

FIG. 8A shows a cross-sectional view of a related-art electrophoretic display 100. The electrophoretic display 100 is, for example, a black and white electrophoretic display 100. The electrophoretic display 100 includes, from top to bottom, a charge balance substrate 12 (for example, a transparent plastic substrate), a charge balance electrode 14 (for example, a transparent conductive electrode layer), an electrophoretic layer (display layer) 20, a control electrode layer PEL, a driving circuit layer 30a and a control substrate 10 (for example, a glass substrate). In the structure shown in FIG. 8A, the viewing surface is along a direction facing the charge balance substrate 12. In addition, as shown in FIG. 8A, the electrophoretic layer 20 includes a plurality of microcontainers 22 (only one of which is shown in the figure). The colloidal solution 24 filled in each microcontainer 22 contains a plurality of suspended charged color particles 26 (for example, charged black particles 26B and charged white particles 26W). The microcontainer 22 structure is used as a container for electronic ink (or electrophoretic material). The microcontainer 22 is made of, for example, organic polymer material, and is used to fill the charged color particles 26. In addition, the charged color particles 26 may be two-color combinations (black/white), three-color combinations (black/red/white, black/yellow/white), four-color combinations (black/red/yellow/white, cyan/yellow)/magenta/white) and other combinations. In the structure shown in FIG. 1A, the charged color particles 26 are, for example, a two-color combination and include charged black particles 26B and charged white particles 26W. Furthermore, the microcontainer 22 may be a microcapsule (for example, the microcapsule in U.S. Pat. Nos. 7,535,624 and 5,961,804) structure or a micro-cup (for example, the micro-cup in Taiwan Invention TW I230832B).

The charge balance electrode 14 is generally connected to the ground potential (0V) to provide a common voltage Vcom, and the control substrate 10 below the charge balance electrode 14 generally uses TFT Array process of the display panel to fabricate the driving circuit layer 30a thereon. The driving switches of the driving circuit layer 30a generally employ thin film transistors made by an amorphous silicon (a-Si) process. The charged color particles 26 have charges of a predetermined polarity, for example, the charged black particles 26B are positively charged and the charged white particles 26W are negatively charged. By controlling the voltage polarity and voltage magnitude on each control electrode PE with the driving circuit layer 30a, the charged black particles 26B can be attracted and the charged white particles 26W can be expelled for a corresponding pixel (making the pixel on the viewing surface opposite to the control electrode PE to exhibit white color), or the charged black particles 26B can be expelled and the charged white particles 26W can be attracted for a corresponding pixel (making the pixel on the viewing surface opposite to the control electrode PE to exhibit black color).

FIG. 8B is a schematic diagram illustrating the operation of the related art black and white electrophoretic display 100 in FIG. 8A. As shown in FIG. 8B, by controlling the voltage polarity and voltage magnitude of each control electrode PE (such as PE1, PE2, and PE3) in the control electrode layer PEL through the driving circuit layer 30a, black and white pixels can be formed on the viewing surface (closer to the charge balance substrate 12 than the control substrate 10). If the driving circuit layer 30a controls the control electrodes (such as PE1 and PE3) shown in FIG. 8B to have positive voltage, the control electrodes attract the negatively charged white particles 26W and expel the positively charged black particles away from the surface in contact with the control electrodes and toward the viewing surface, resulting in relatively large numbers of positively charged black particles 26B on the viewing surface to provide black pixels on the viewing surface. On the contrary, if the driving circuit layer 30a controls the control electrode (such as PE2) shown in FIG. 8B to have a negative voltage, the control electrodes attract the positively charged black particles 26B and expel the negatively charged white particles 26W away from the surface in contact with the control electrodes and toward the viewing surface, resulting in relatively large numbers of negatively charged white particles 26W on the viewing surface to provide white pixels on the viewing surface.

As shown in FIG. 8B, and also referring to FIG. 7, the charge balance electrode 14 (CE) is usually electrically connected to the ground potential (0V, that is, V com potential) and the electrophoretic layer 20 is sandwiched between the charge balance electrode 14 (CE) and the control electrode layer PEL. A capacitance (electrophoretic capacitance Cp) is formed between the control electrode PE of the control electrode layer PEL and the Vcom potential. Since the thickness of the electrophoretic layer is generally thick, the above-mentioned capacitance is very small, and the charge on the control electrode quickly interacts with the charged particles to achieve balance. The distance travelled by the charged particles is very small. A storage capacitor must be added in the driving circuit layer 30a to increase the energy for driving each travel. One end of the storage capacitor is connected to the control electrode, and the other end of the storage capacitor is connected to the conductor on one face of the electrophoretic layer and opposite to the control electrode, thus forming the storage capacitor Cs with parallel planes. In FIG. 7, the equivalent circuit of the electrophoretic layer 20 is labeled with the electrophoretic capacitor Cp and further includes above-mentioned storage capacitor Cs. As shown in FIG. 7, the driving circuit layer 30a includes a plurality of thin film transistors 32. The gate metal of each thin film transistor 32 is electrically connected to the gate line GL (for example, the gate line GL is made of the metal 1 layer M1), the source metal of each thin film transistor 32 is electrically connected to the data line DL (for example, the data line DL is made of the metal 2 layer M2), and the drain metal of each thin film transistor 32 is electrically connected to the corresponding control electrode (also referred to as pixel electrode) PE. According to the potential applied to the gate metal by the gate line GL, the thin film transistor 32 can be determined to be turned on (On) or turned off (Off); thus determining whether the voltage on the data line DL will be transmitted to the drain metal through the source metal and then further sent to the corresponding control electrode PE to charge the storage capacitor Cs to have voltage the same as the voltage on the data line.

Besides, the control electrode PE will also apply the voltage on the corresponding data line to the electrophoretic layer 20. Generally, the driving circuit layer includes multiple thin film transistors, multiple gate lines, and multiple data lines. Each gate line is electrically connected to the gates of the plurality of thin film transistors, each of the data lines is electrically connected to the drains or sources of the plurality of thin film transistors. The driving circuit layer also includes a plurality of control electrodes, each of the control electrodes is electrically connected to the source or the drain of the thin film transistors.

The electrophoretic layer includes electrophoretic material. The electrophoretic material includes a plurality of charged color particles. The plurality of charged color particles are arranged in a colloidal solution and can move through the colloidal solution under the influence of an electric field. The plurality of charged color particles include positively charged color particles and/or negatively charged color particles. The charged color particles 26 move under the force of the electric field in the colloidal solution 24 of the electrophoretic layer 20 with appropriate viscosity. The moving speed of the charged color particles 26 is generally very slow. The driving circuit layer 30a first quickly stores energy in the storage capacitor Cs, and then the storage capacitor Cs slowly releases the energy to the electrophoretic layer 20 through the control electrode PE and the released energy is an energy source for the movement of the charged color particles 26. The larger the capacitance value of the storage capacitor Cs, the more energy can be stored. Therefore, the energy storage only needs to be repeated with fewer times and the electrophoretic display 100 has faster picture update speed. Therefore, in the circuit layout design of the electrophoretic display 100, the area of the storage capacitor Cs needs to be increased to increase the capacitance value. However, in a system with multi-color charged color particles, the moving distance and direction of the charged color particles need to be accurately controlled. The capacitance value of the storage capacitor Cs is generally reduced to lower the energy supply and increase the accuracy for controlling the moving distance of the charged color particles. However, the above scheme needs more times for energy storage and is at the expense of reducing the update speed of the electrophoretic display 100.

FIGS. 1A and 1C respectively shows the simplified schematic diagram and equivalent circuit diagram for partial pixel unit in FIG. 8A. There is an electrophoretic capacitor Cp between the charge balance electrode CE and the pixel electrodes (control electrodes) PE1˜PE3, and there is a storage capacitor Cs between the pixel electrodes (control electrodes) PE1˜PE3 and the capacitance electrode CM. FIG. 1B is a schematic view showing the movement of the charged color particles (such as positively charged color particles and negatively charged color particles) when there is no applied voltage, there is positive voltage and there is negative voltage on the control electrodes PE1 to PE3. When there is no applied voltage on the control electrodes PE1 to PE3, the charged color particles are normally and randomly distributed. Therefore, the equivalent capacitance value of the electrophoretic capacitor Cp is relatively small. When there is positive voltage or negative voltage applied to the control electrodes PE1 to PE3, the charged color particles are affected by the applied voltage and move along the direction toward the charge balance electrode CE and the control electrodes PE1˜PE3 respectively, so the equivalent capacitance value of the electrophoretic capacitor Cp is relatively larger.

Referring to parts (A) to (E) in FIG. 2A, those parts show three different voltage applied status for a pixel unit in an electrophoretic display (parts (A) to (C)), the voltage applied circuit (part (D)) and applied voltage waveforms (part (E)). With reference to part (D) of FIG. 2A, the gate of the thin film transistor 32 receives the gate voltage Vg, and the drain of the thin film transistor 32 supplied the control voltage Vst to the control electrode PE to change the electrophoretic capacitance Cp. Please refer to part (E) of FIG. 2A, in stage A, the gate voltage Vg and the control voltage Vst are both at low level, and as shown in part (A) of FIG. 2A, the charged color particles are normally and randomly distributed. In stage B, the gate voltage Vg and the control voltage Vst are both at high level. As shown in part (B) of FIG. 2A, the charged color particles are affected by the voltage and begin to move toward the charge balance electrode CE and the control electrode PE respectively. In stage C, the gate voltage Vg is at low level and the control voltage Vst gradually decreases. As shown in part (C) of FIG. 2A, the charged color particles are still affected by the voltage and continue to move toward the charge balance electrode CE and the control electrode PE respectively because there is still a positive control voltage Vst. In other words, more charged color particles are still affected by the voltage and move to the charge balance electrode CE and the control electrode PE respectively until the charge is balanced. Please refer also to part (B) of FIG. 2A. When a positive control voltage Vst is just applied to the control electrode PE, since the capacitance of the storage capacitor Cs is much larger than the capacitance of the electrophoretic capacitor Cp, the charge on electrophoretic capacitor Cp can be ignored and the charge balance electrode CE is electrically neutral. There are positive charges on the control electrode PE (for example, 16 positive charges as shown in the figure), while there are relative negative charges on the capacitor electrode CM (for example, 16 negative charges as shown in the figure). As the control voltage Vst continues to be applied, the negatively charged color particles in the electrophoretic layer 20 will be attracted to be close to the control electrode PE. At the same time, the negative charges of the capacitor electrode CM flow to the charge balance electrode CE. The negative charges flowed to the charge balance electrode CE attract the positively charged color particles in the electrophoretic layer 20 to be close to the charge balance electrode CE until the charge balance is achieved. For example, as shown in part (C) of FIG. 2A, during charge balance there are approximately the same amount of charges on the charge balance electrode CE and the capacitor electrode CM. For example, there are 8 negative charges on the charge balance electrode CE and the capacitor electrode CM respectively. However, the number of charges in above example is only for illustration and not for exact numbers.

Referring to parts (A) to (E) in FIG. 2B, those parts show three different voltage applied status for a pixel unit in an electrophoretic display (parts (A) to (C)), the voltage applied circuit (part (D)) and applied voltage waveforms (part (E)). As shown in part (E) of FIG. 2B, the voltage applied to the pixel unit of the electrophoretic display shown in FIG. 2B is similar to that shown in FIG. 2A, but a negative voltage is applied to the control voltage Vst. Therefore, the moving ways of the positively charged color particles and the negatively charged color particles in parts (B) and (C) in FIG. 2B are opposite to those shown in parts (B) and (C) in FIG. 2A.

However, in the related art electrophoretic display, the electric power for moving the charged color particles is only provided by the control voltage applied to the pixel electrode. The moving speed and quantity of the charged color particles are insufficient, which affects the response speed of the related art electrophoretic display.

### SUMMARY

It is an object of the present invention to provide an electrophoretic display with charge balance enhancing circuit to speed up the movement speed and amount of the charged color particles and to improve the response speed of the electrophoretic display.

Accordingly, the present invention provides an electrophoretic display with charge balance enhancing circuit, the electrophoretic display comprising:
a control substrate comprising a plurality of thin film transistors, a plurality of pixel electrodes and a plurality of capacitance electrodes electrically connected to each other, a plurality of storage capacitors, wherein one of the storage capacitors is arranged with one of the capacitance electrodes;
a charge balance substrate;
a charge balance electrode arranged on a side close to the charge balance substrate;
a display layer arranged on one side of the control substrate and comprising a plurality of microcontainers, the microcontainers being filled with a colloidal solution, and the colloidal solution containing at least one charged color particle;
a charge balance enhancing circuit comprising:
a charge-voltage conversion capacitor having a first terminal and a second terminal;
wherein the capacitance electrode of one of the storage capacitors of the control substrate is electrically connected to the first terminal of the charge-voltage conversion capacitor and the charge balance electrode is electrically connected to the second terminal of the charge-voltage conversion capacitor.

### BRIEF DESCRIPTION OF THE DRAWINGS

FIG. 1A shows a simplified schematic diagram for the partial pixel units in related art electrophoretic display.

FIG. 1B is a schematic view showing the movement of the charged color particles under different applied voltages.

FIG. 1C shows the equivalent circuit diagram for partial pixel unit in FIG. 1A.

FIG. 2A shows three different voltage applied status for a pixel unit in related art electrophoretic display, the voltage applied circuit and applied voltage waveforms respectively in parts (A)˜(E).

FIG. 2B shows three different voltage applied status for a pixel unit in related art electrophoretic display, the voltage applied circuit and applied voltage waveforms respectively in parts (A)˜(E).

FIG. 3A shows three different voltage applied status for a pixel unit in the electrophoretic display, the voltage applied circuit and applied voltage waveforms respectively in parts (A)˜(E) according to the present invention.

FIG. 3B shows three different voltage applied status for a pixel unit in the electrophoretic display, the voltage applied circuit and applied voltage waveforms respectively in parts (A)˜(E) according to the present invention.

FIG. 4A shows the schematic view of the electrophoretic display with charge balance enhancing circuit according to an embodiment of the present invention.

FIG. 4B is an equivalent circuit diagram of the electrophoretic display with charge balance enhancing circuit according to an embodiment of the present invention.

FIG. 4C is a circuit diagram of the charge balance enhancing circuit according to an embodiment of the present invention.

FIG. 5A shows the schematic diagram of a color electrophoretic display.

FIG. 5B shows the schematic diagram of another color electrophoretic display.

FIG. 6A is a circuit diagram showing the connection between the charge balance enhancing circuit and other components according to an embodiment of the present invention.

FIG. 6B is a circuit diagram showing the connection between the charge balance enhancing circuit and other components according to another embodiment of the present invention.

FIG. 7 is a circuit diagram showing partial elements in the driving circuit layer.

FIG. 8A is a sectional view of a related art electrophoretic display.

FIG. 8B shows the operation of the electrophoretic display in FIG. 8A.

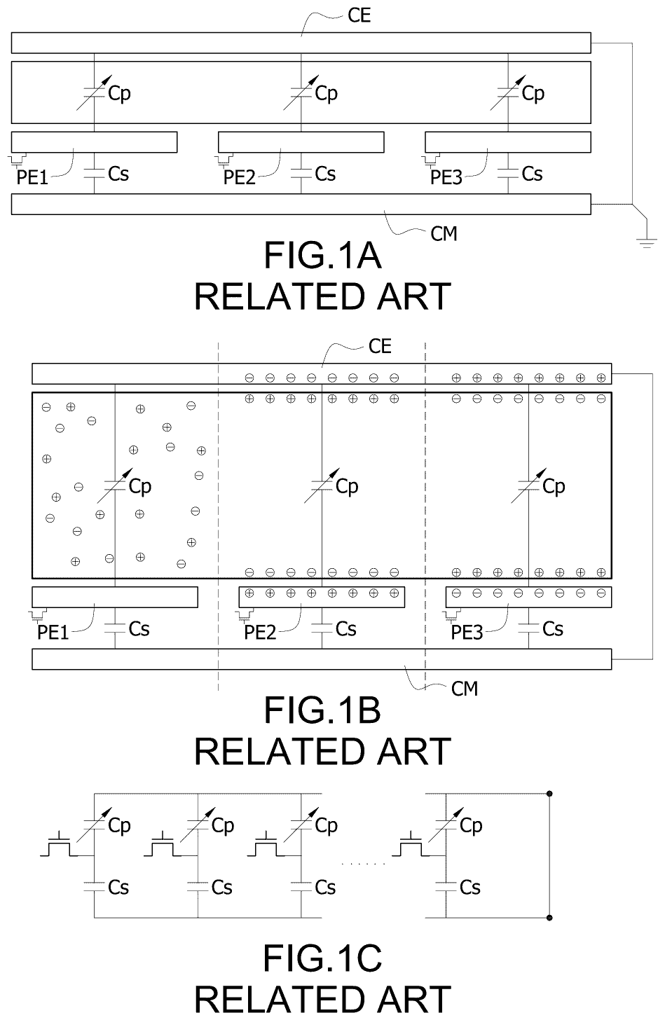

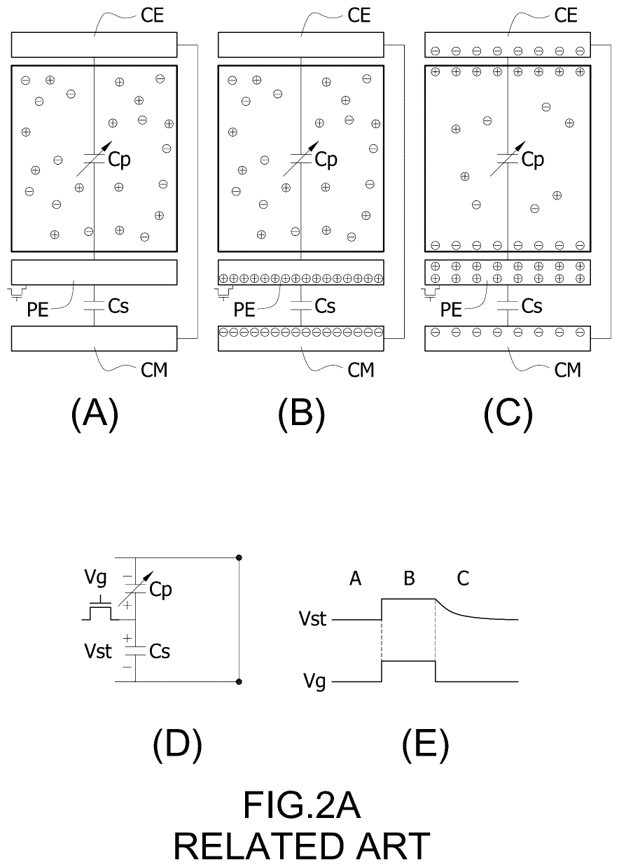

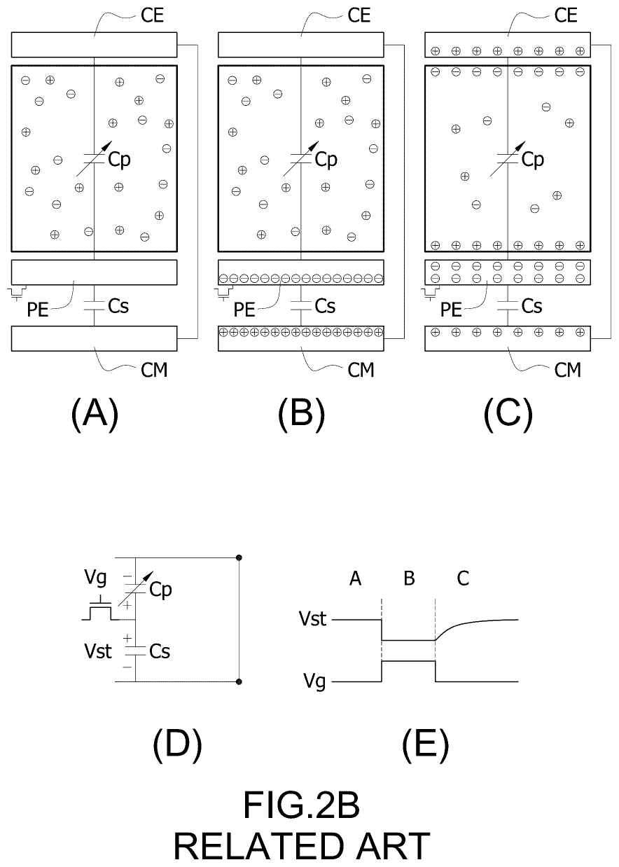

### DETAILED DESCRIPTION

It is to be understood that the terms for indicating positions and the location relation, for example “front”, “rear”, “left”, “right”, “front end”, “rear end”, “distal end”, “longitudinal direction”, “lateral direction”, “vertical direction”, “top” and “bottom”, are based on the positions and the location relation disclosed in the drawings, and only used for disclosing the present invention and not used for indicating or implying the specified location of the device or the components or the specified structure and operation in certain location, thus the present invention is not intended to be limiting.

For example, the terms of “first”, “second”, “third”, “forth” and “fifth” are used for illustrating each unit, component, area, layer and/or part. The component, the unit, the area, the layer and/or the part are not limited by the terms. These terms are only used for separating the element, the assembly, the area, the layer, or the part. Unless being clearly indicated according to the whole specification, the terms for example “the first”, “the second”, “the third”, “the fourth” and “the fifth” are not used for implying the order or sequence.

As used herein and not otherwise defined, the terms “substantially” and “approximately” are used to describe and describe small changes. When used in connection with an event or situation, the terms may include the precise moment at which the event or situation occurs, as well as the event or situation occurring to a close approximation. For example, when combined with a numerical value, the terms may include a range of variation equal to or less than ±5% of the numerical value, such as equal to or less than ±4%, equal to or less than ±3%, equal to or less than ±2%, equal to or less than ±1%, equal to or less than ±0.5%, equal to or less than ±0.1%, or equal to or less than ±0.05%.

The technical contents of the present invention will become apparent with the detailed description of embodiments and the accompanied drawings as follows. However, it shall be noted that the accompanied drawings are for illustrative purposes only such that they shall not be used to restrict the scope of the present invention.

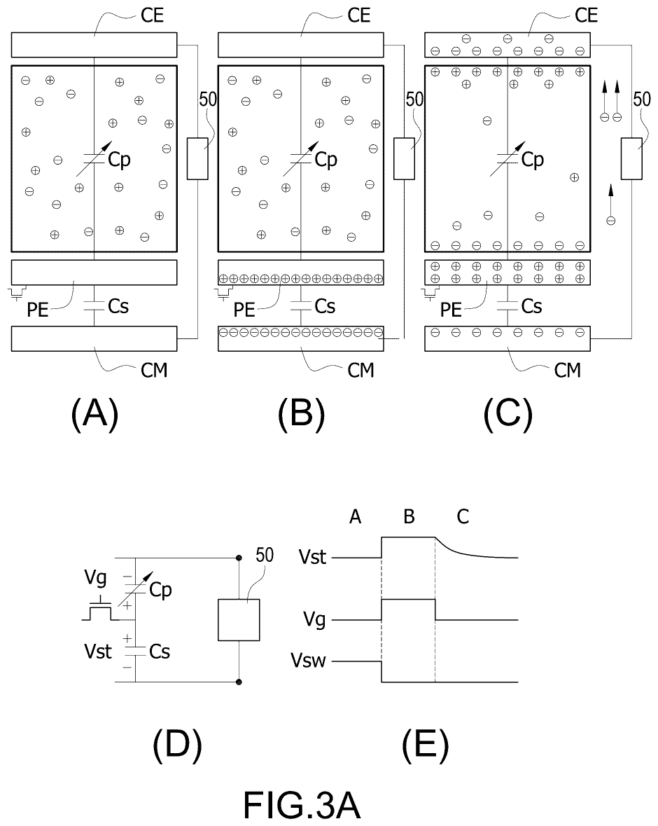

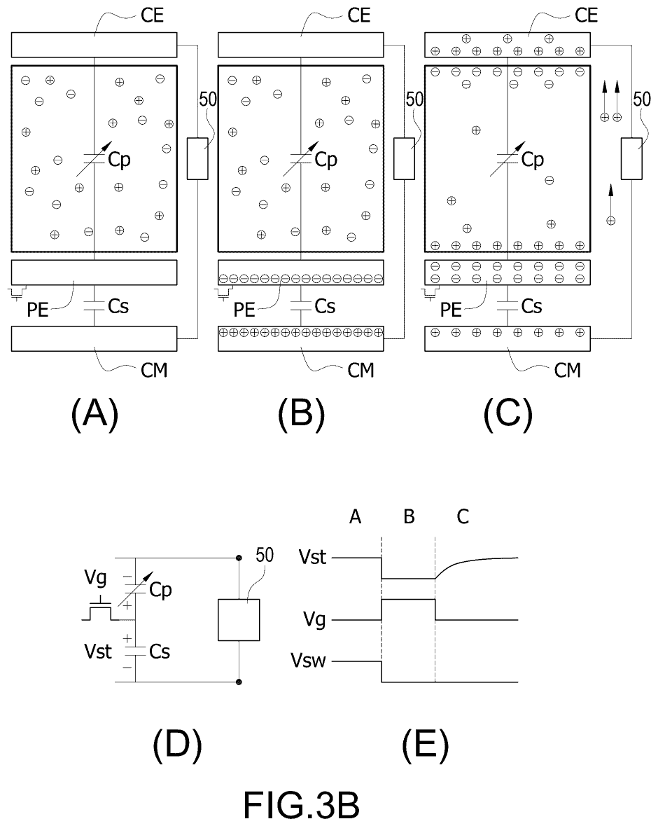

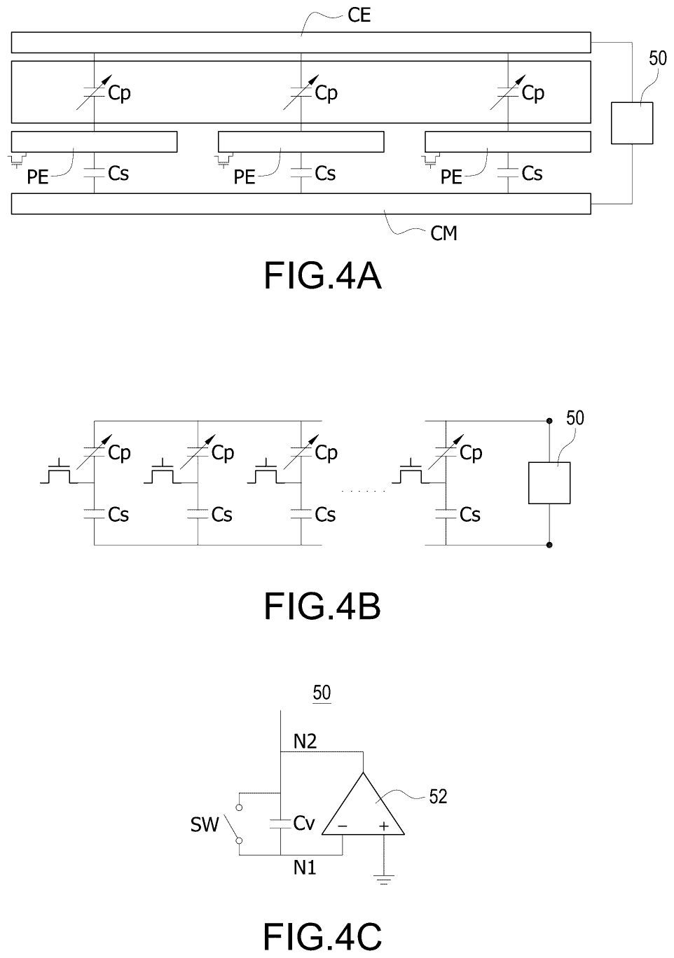

Referring to parts (A) to (E) in FIG. 3A, those parts show three different voltage applied status for a pixel unit in an electrophoretic display (parts (A) to (C)), the voltage applied circuit (part (D)) and applied voltage waveforms (part (E)) according to the present invention. Referring to FIGS. 4A, 4B and 4C, FIG. 4A shows the schematic view of the electrophoretic display with charge balance enhancing circuit according to an embodiment of the present invention; FIG. 4B is an equivalent circuit diagram of the electrophoretic display with charge balance enhancing circuit according to an embodiment of the present invention; and FIG. 4C is a circuit diagram of the charge balance enhancing circuit according to an embodiment of the present invention.

Referring first to FIGS. 3A and 4C, the charge balance enhancing circuit 50 according to an embodiment of the present invention includes, for example, an operational amplifier 52, a charge-voltage conversion capacitor Cv having a first terminal N1 and a second terminal N2, and a bypass switch SW arranged between the first terminal N1 and the second terminal N2 of the charge-voltage conversion capacitor Cv. The gain of the operational amplifier 52 is, for example, greater than one or equal to one.

Please refer to part (A) of FIG. 3A and also refer to part (E) of FIG. 3A. Before the displayed content of the electrophoretic display is updated, namely in stage A, the gate voltage Vg and the control voltage Vst are both at low level while the switching voltage Vsw of the bypass switch SW is at high level (short circuited), the charged color particles are normally and randomly distributed. After the displayed content of the electrophoretic display starts updating, namely in stage B, the gate voltage Vg and the control voltage Vst are both at high level while the switching voltage Vsw of the bypass switch SW is at low level (open circuited). As shown in part (B) of FIG. 3A, the charged color particles are affected by the voltage and begin to move toward the charge balance electrode CE and the control electrode PE respectively. In stage C, the gate voltage Vg is at low level and the control voltage Vst gradually decreases. As shown in part (C) of FIG. 3A, the charged color particles are still affected by the voltage and continue to move toward the charge balance electrode CE and the control electrode PE respectively because there is still a positive control voltage Vst. In other words, more charged color particles are still affected by the voltage and move to the charge balance electrode CE and the control electrode PE respectively until the charge is balanced.

As shown in part (C) of FIG. 3A, by the action of the charge balance enhancing circuit 50 according to the present invention, more charges move to the charge balance electrodes CE, and more charged color particles are attracted to move toward the charge balance electrodes CE and the control electrodes PE respectively, thus speeding up the display updating. The more detailed mechanism of the charge balance enhancing circuit 50 will be explained later with other figures. Please also refer to part (B) of FIG. 3A. When a positive control voltage Vst is just applied to the control electrode PE, the charge balance electrode CE is electrically neutral while there are positive charges on the control electrode PE (for example, 16 positive charges in the figure), and there are relative negative charges on the capacitor electrode CM (for example, 16 negative charges in the figure). At the same time, the negative charges of the capacitor electrode CM flow to the charge balance electrode CE and the flowed negative charges attract the positively charged color particles in the electrophoretic layer 20 to positions close to the charge balance electrode CE. Besides, the charge balance enhancing circuit 50 of the present invention also provides negative charges to the charge balance electrode CE. Therefore, the charge balance electrode CE flows more negative charges than the capacitor electrode CM does. For example, as shown in part (C) in FIG. 3A, the capacitor electrode CM has 8 negative charges remaining (namely, it flows out 8 negative charges), while the charge balance electrode CE flows out more negative charges (for example, 11 negative charges) than the capacitor electrode CM does. Namely, part of the negative charges of the charge balance electrode CE are provided by the charge balance enhancing circuit 50 of the present invention. Therefore, the charge color particles have faster speed to move to desired position, this helps to speed up screen update rate. However, above example and number are only for illustration.

With reference to parts (A) to (E) of FIG. 3B, those figures respectively show three different voltage applied status for a pixel unit in an electrophoretic display (parts (A) to (C)), the voltage applied circuit (part (D)) and applied voltage waveforms (part (E)) according to the present invention. As apparent from part (E) in FIG. 3B, the voltage application manner for FIG. 3B is similar to that for FIG. 3A. However, a negative voltage is applied to the control voltage Vst. Therefore, the moving ways of the positively charged color particles and the negatively charged color particles in parts (B) and (C) in FIG. 3B are opposite to those shown in parts (B) and (C) in FIG. 3A. Similarly, by the provision of the charge balance enhancing circuit 50 of the present invention, more charges move to the charge balance electrode CE, and the movement of the charged color particles is speeded up toward the charge balance electrode CE and the control electrode PE, respectively. Namely, more charged color particles move to the desired display position and this speeds up the screen update rate.

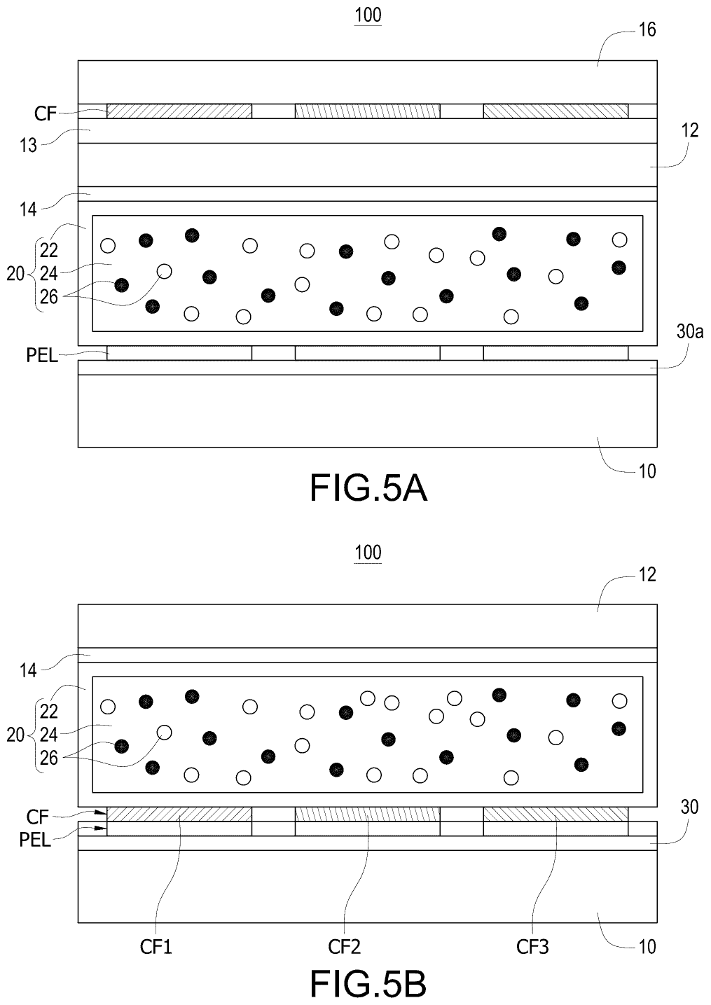

FIG. 5A shows the schematic diagram of a color electrophoretic display 100. The charge balance enhancing circuit 50 of the present invention is applicable to the color electrophoretic display 100 shown in FIG. 5A. As shown in FIG. 5A, the electrophoretic display 100 includes, from top to bottom, an upper glass substrate 16, a color filter layer CF, an optical glue 13, a charge balance substrate 12 (for example, a transparent plastic substrate), a charge balance electrode 14 (for example, a transparent conductive electrode layer), an electrophoretic layer (display layer) 20, a control electrode layer PEL, a driving circuit layer 30a and a control substrate 10 (for example, a glass substrate). In the structure shown in FIG. 5A, the viewing surface is close to the charge balance substrate 12 (namely, also close to the upper glass substrate 16). In addition, as shown in FIG. 5A, the display layer 20 includes a plurality of microcontainers 22 (only one microcontainer 22 is shown in the figure). The colloidal solution 24 filled in each microcontainer 22 contains a plurality of suspended charged color particles 26 (for example, charged black particles 26B and charged white particles 26W). The microcontainer 22 structure is used as a container for electronic ink (or electrophoretic material). The microcontainer 22 is made of, for example, an organic polymer material, and is used to fill the charged color particles 26.

FIG. 5B shows the schematic diagram of another color electrophoretic display 100. The charge balance enhancing circuit 50 of the present invention is also applicable to the color electrophoretic display 100 shown in FIG. 5B. As shown in FIG. 5B, the electrophoretic display 100 includes, from top to bottom, a charge balance substrate 12 (for example, a transparent plastic substrate), a charge balance electrode 14 (for example, a transparent conductive electrode layer), an electrophoretic layer (display layer) 20, a color filter layer CF, a control electrode layer PEL, a high opening ratio driving circuit layer 30 (hereinafter briefed as driving circuit layer 30) and a control substrate 10. Similarly, the display layer 20 includes a plurality of microcontainers 22 (only one microcontainer 22 is shown in FIG. 5B). The colloidal solution 24 filled in each microcontainer 22 contains a plurality of suspended charged color particles 26 (for example, charged black particles 26B and charged white particles 26W). The microcontainer 22 structure is a hollow cavity formed by organic polymer material and is used as a container for charged color particles 26. According to another embodiment (not shown) of the present invention, the microcontainer 22 can also be filled with a colloidal solution 24, where the colloidal solution 24 contains a colored fluid (such as black fluid) and a plurality of charged particles of a single color (such as charged white particles). The microcontainer 22 is used as a container for electronic ink.

The microcontainer 22 may be a microcapsule (for example, the microcapsule in U.S. Pat. Nos. 7,535,624 and 5,961,804) structure or a micro-cup (for example, the micro-cup in Taiwan Invention TW I230832B). Besides, the microcontainer 22 may be micro partition (for example, the micro partition in Taiwan Patent App. No. 112135041 filed by the same applicant).

Furthermore, in embodiments other than those shown in FIGS. 5A and 5B, the color electrophoretic display 100 of the present invention may not have the color filter layer CF, and/or the colloidal solution 24 of the display layer 20 includes a plurality of charged black particles, a plurality of charged white particles, and a plurality of charged red particles. Besides, the colloidal solution 24 of the display layer 20 of the present invention may include a plurality of charged black particles, a plurality of charged white particles, a plurality of charged red particles, and a plurality of charged yellow particles. The colloidal solution 24 of the display layer 20 of the present invention may include a plurality of charged white particles, a plurality of charged yellow particles, a plurality of charged magenta particles, and a plurality of charged cyan particles. The colloidal solution 24 of the display layer 20 of the present invention may include a plurality of charged white particles, a plurality of charged red particles, a plurality of charged yellow particles, and a plurality of charged blue particles. The above combinations of charged color particles are all within the scope of the present invention.

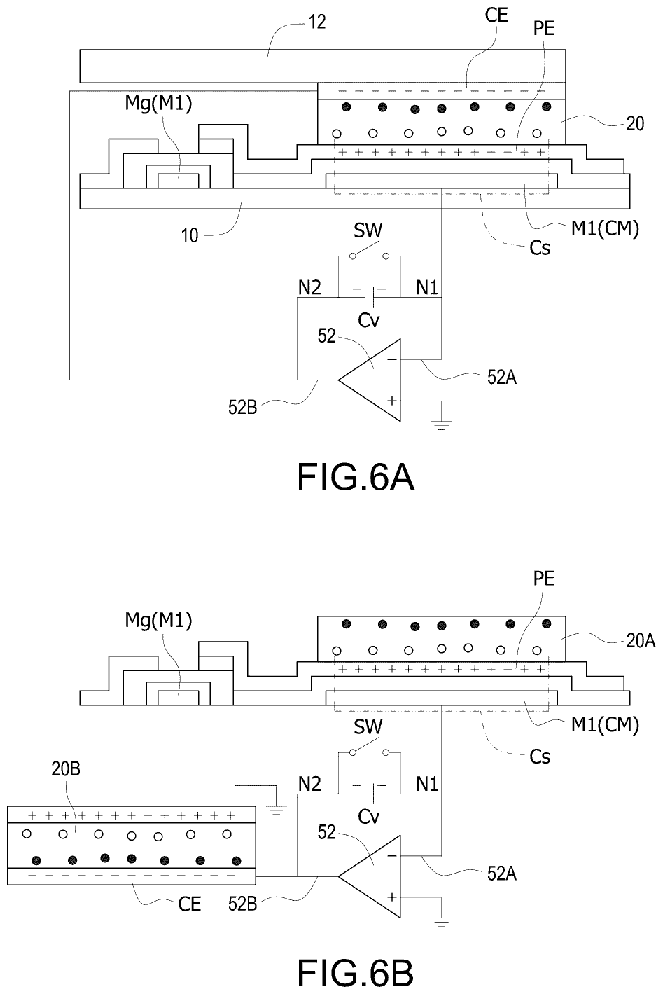

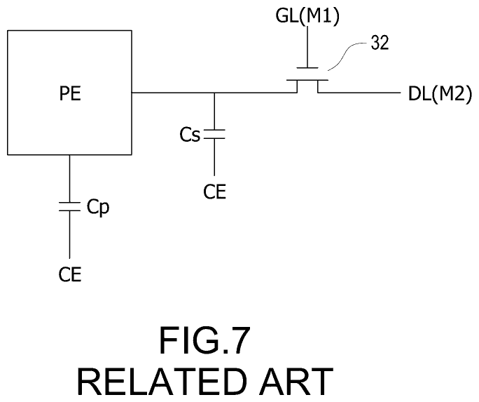

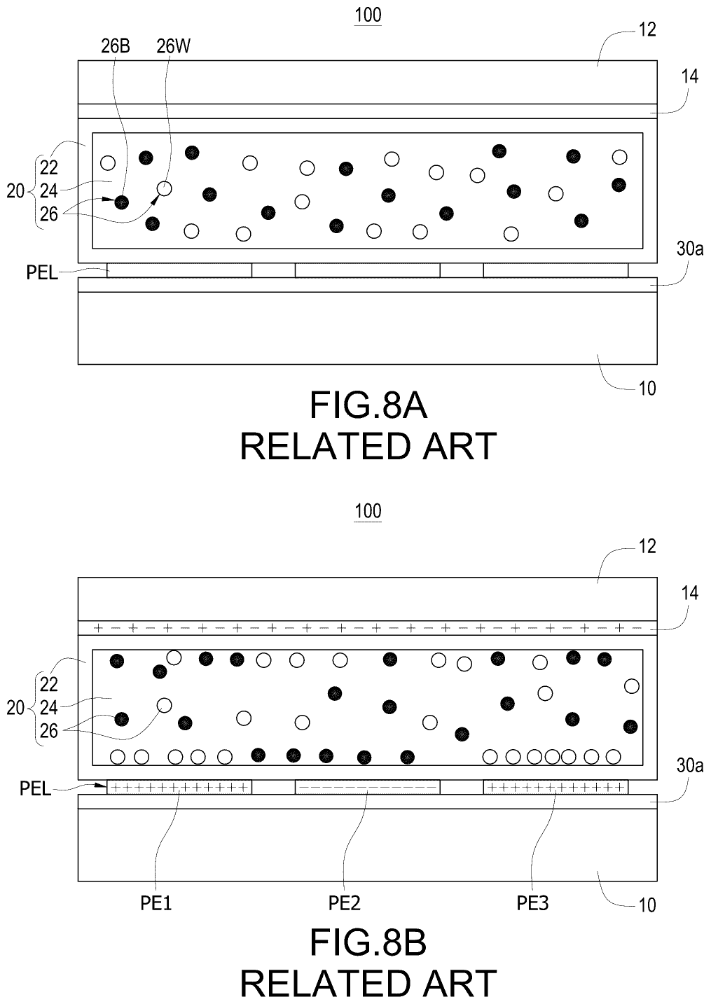

FIG. 6A is a circuit diagram showing the connection between the charge balance enhancing circuit 50 and other components. As shown in this figure, the charge balance enhancing circuit 50 is electrically connected to relevant components of the electrophoretic display 100 shown in FIG. 5A and FIG. 5B. More specifically, the charge balance enhancing circuit 50 includes an operational amplifier 52. The input terminal 52A (for example, an inverting input terminal) of the operational amplifier 52 is electrically connected to the first terminal N1 of the charge-voltage conversion capacitor Cv and the capacitance electrode CM. The output terminal 52B of the operational amplifier 52 is electrically connected to the second terminal N2 of the charge-voltage conversion capacitor Cv and the charge balance electrode CE.

Please refer also to part (E) of FIG. 3A, before display screen of the electrophoretic display starts updating, namely in stage A, both the gate voltage Vg and the control voltage Vst are at low level. The switching voltage Vsw of the bypass switch SW is at high level (short circuited), and the output voltage of the second terminal N2 is ground level (GND) according to the concept of virtual ground in operational amplifier. At this time, the charged color particles of the display layer 20 are generally in normal and random distribution. After the display screen of the electrophoretic display starts updating, namely in stage B, both the gate voltage Vg and the control voltage Vst are at high level. The switching voltage Vsw of the bypass switch SW is at low level (opened circuited). At this time, a positive voltage is applied to the control electrode PE to attract negatively charged particles. A negative voltage is outputted from the output of the operational amplifier 52 and applied to the capacitance electrode CM through the charge-voltage conversion capacitor Cv. As shown in FIG. 6A, the first terminal N1 of the charge-voltage conversion capacitor Cv has positive charges, while the second terminal N2 of the charge-voltage conversion capacitor Cv has negative charges. The charges at the first terminal N1 have polarity opposite to the charges at the capacitance electrode CM.

The input terminal 52A of the operational amplifier 52 is virtual ground, and the first terminal N1 of the charge-voltage conversion capacitor Cv is at positive level relative to the second terminal N2. When the electrophoretic display enters the stage C, the first terminal N1 and the capacitance electrode CM attract each other due to the opposite charge polarity therebetween. Therefore, the charges at the capacitance electrode CM can be moved out faster. When the charges at the first terminal N1 are combined with the charges at the capacitance electrode CM, the charges at the second terminal N2 are expelled to the charge balance electrode CE such that electrons flow to the charge balance electrode CE with faster speed to achieve balance. Namely, the charge balance enhancing circuit 50 can move more electrons with negative charges to the charge balance electrode to speed up the movement of the charged color particles toward the charge balance electrode CE and the control electrode PE, respectively. Namely, more charged color particles are moved to desired position for display to speed up the screen update rate.

In the circuit shown in FIG. 6A, the capacitance electrode CM is connected to virtual ground rather than the actual ground. This kind of connection avoids the accumulation of static charges in the actual ground and prevents incorrection operation of other circuits, which is due to non-neutral charges in ground level of circuit. According to formular for capacitance: Q=CV, the voltage across the charge-voltage conversion capacitor Cv becomes larger as the capacitance value of the charge-voltage conversion capacitor Cv becomes smaller (namely the gain of the operational amplifier circuit 52 becomes large). Therefore, the movement of the electrons to the charge balance electrode CE can be speeded up.

FIG. 6B is a circuit diagram showing the connection between the charge balance enhancing circuit 50 and other components according to another embodiment of the present invention. As shown in this figure, the charge balance enhancing circuit 50 is electrically connected to relevant components of the electrophoretic display 100 shown in FIG. 5A and FIG. 5B. More specifically, the charge balance enhancing circuit 50 includes an operational amplifier 52. The input terminal 52A (for example, an inverting input terminal) of the operational amplifier 52 is electrically connected to the first terminal N1 of the charge-voltage conversion capacitor Cv and the capacitance electrode CM. The output terminal 52B of the operational amplifier 52 is electrically connected to the second terminal N2 of the charge-voltage conversion capacitor Cv and the charge balance electrode CE.

The embodiment shown in FIG. 6B includes two display layers, namely a first display layer 20A and a second display layer 20B. The structure and the operation of the first display layer 20A are similar to those of the display layer 20 shown in FIG. 6A. The second display layer 20B may be arranged on a substrate different from that of the control substrate 10 to provide different display contents for the electrophoretic display 100. For example, dual side display can be achieved. Similarly, before the electrophoretic display screen starts updating, namely in stage A, both the gate voltage Vg and the control voltage Vst are at low level. The switching voltage Vsw of the bypass switch SW is at high level (short circuited). At this time, the charged color particles of the first display layer 20A and the second display layer 20B are generally in normal and random distribution. After the display screen of the electrophoretic display starts updating, namely in stage B, both the gate voltage Vg and the control voltage Vst are at high level. The switching voltage Vsw of the bypass switch SW is at low level (opened circuited). At this time, a positive voltage is applied to the control electrode PE to attract negatively charged particles, and a negative voltage is applied to the capacitance electrode CM in the first display layer 20A.

The input terminal 52A of the operational amplifier 52 is virtual ground, and the first terminal N1 of the charge-voltage conversion capacitor Cv is at a positive level relative to the second terminal N2. This can accelerate the flow of electrons to the capacitor electrode CM. In addition, for the second display layer 20B, the electric current flows from the charge balance electrode CE to the output terminal 52B of the operational amplifier 52, the charges on the charge balance electrode CE are negative such that the charge balance electrode CE is at a negative level relative to the ground. The charge balance electrode CE accordingly attracts positively charged color particles. The electrode opposite to the charge balance electrode CE is at positive level and attracts negatively charged color particles. This can achieve charge balance effect.

Even though not explicitly shown in the figure, the charge balance enhancing circuit 50 is disposed in a control integrated circuit chip, where the control integrated circuit chip is arranged on a surface of the control substrate 10. Alternatively, the charge balance enhancing circuit 50 may also be arranged in a control integrated circuit chip, where the control integrated circuit chip is arranged on a surface of a flexible circuit board, and one end of the flexible circuit board is pressed against one end of the control substrate 10.

Besides, in the above embodiments, the charge balancing substrate 12 is a transparent substrate, such as a glass substrate or a polymer substrate. The control substrate 10 is a transparent substrate, such as a glass substrate or a polymer substrate. The charge balancing electrode CE is a transparent conductive electrode, such as an indium tin oxide electrode (ITO) electrode. The plurality of pixel electrodes PE and the plurality of capacitance electrodes CM may also be transparent conductive electrodes, such as indium tin oxide electrodes (ITO) electrodes. The plurality of thin film transistors 32 are amorphous silicon thin film transistors or organic thin film transistors.

To sum up, the present invention provides an electrophoretic display with charge balance enhancing circuit. This charge balance enhancing circuit can accelerate the movement speed and quantity of charged color particles when the display screen of the electrophoretic display is updated and the response speed of the electrophoretic display is also improved.

It shall be understood that the present invention may have other types of embodiments, and a person with ordinary skills in the art of the technical field of the present invention may make various changes and modifications corresponding to the present invention without deviating the principle and substance of the present invention; however, such corresponding changes and modification shall be considered to be within the claimed scope of the present invention.

What is claimed is:

1. An electrophoretic display with charge balance enhancing circuit, the electrophoretic display comprising:
a control substrate comprising a plurality of thin film transistors, a plurality of pixel electrodes and a plurality of capacitance electrodes electrically connected to each other, a plurality of storage capacitors, wherein one of the storage capacitors is arranged with one of the capacitance electrodes;
a charge balance substrate;
a charge balance electrode arranged on a side close to the charge balance substrate;
a display layer arranged on one side of the control substrate and comprising a plurality of microcontainers, the microcontainers being filled with a colloidal solution, and the colloidal solution containing at least one charged color particle;
a charge balance enhancing circuit comprising:
a charge-voltage conversion capacitor having a first terminal and a second terminal;
wherein the capacitance electrode of one of the storage capacitors of the control substrate is electrically connected to the first terminal of the charge-voltage conversion capacitor and the charge balance electrode is electrically connected to the second terminal of the charge-voltage conversion capacitor.

2. The electrophoretic display in claim 1, wherein the first terminal of the charge-voltage conversion capacitor is electrically connected to one input end of the charge balance enhancing circuit, the second terminal of the charge-voltage conversion capacitor is electrically connected to an output end of the charge balance enhancing circuit.

3. The electrophoretic display in claim 1, further comprising a bypass switch arranged between the first terminal and the second terminal of the charge-voltage conversion capacitor.

4. The electrophoretic display in claim 3, wherein the bypass switch is short circuited before screen update and is open circuited after screen update is started.

5. The electrophoretic display in claim 1, wherein the microcontainer comprises microcapsule structure.

6. The electrophoretic display in claim 1, wherein the microcontainer comprises micro-cup structure.

7. The electrophoretic display in claim 1, wherein the microcontainer comprises micro partition structure.

8. The electrophoretic display in claim 1, wherein a gain of the charge balance enhancing circuit is equal to or larger than one.

9. The electrophoretic display in claim 1, wherein the charge balance enhancing circuit comprises an operational amplifier.

10. The electrophoretic display in claim 1, wherein the charge balance substrate is a transparent substrate.

11. The electrophoretic display in claim 10, wherein the charge balance electrode is a transparent electrode.

12. The electrophoretic display in claim 11, further comprising a color filter layer arranged on one side of the charge balance electrode.

13. The electrophoretic display in claim 1, wherein the control substrate is a transparent substrate.

14. The electrophoretic display in claim 13, wherein the plurality of pixel electrodes and the plurality of capacitance electrodes are transparent electrodes.

15. The electrophoretic display in claim 14, further comprising a color filter layer arranged on one side of the control substrate.

16. The electrophoretic display in claim 1, wherein the plurality of thin film transistors are amorphous silicon thin film transistors or organic thin film transistors.

17. The electrophoretic display in claim 1, wherein the charge balance enhancing circuit is arranged in a control integrated circuit chip, and the control integrated circuit chip is arranged on a surface of the control substrate.

18. The electrophoretic display in claim 1, wherein the charge balance enhancing circuit is arranged in a control integrated circuit chip, and the control integrated circuit chip is arranged on a surface of a flexible circuit board, and one end of the flexible circuit board is pressed against one end of the control substrate.

19. The electrophoretic display in claim 1, wherein a colloidal solution of the display layer comprises a plurality of charged black particles and a plurality of charged white particles.

20. The electrophoretic display in claim 1, wherein a colloidal solution of the display layer comprises a plurality of charged black particles, a plurality of charged white particles and a plurality of charged red particles.

21. The electrophoretic display in claim 1, wherein a colloidal solution of the display layer comprises a plurality of charged black particles, a plurality of charged white particles, a plurality of charged red particles, and a plurality of charged yellow particles.

22. The electrophoretic display in claim 1, wherein a colloidal solution of the display layer comprises a plurality of charged white particles, a plurality of charged yellow particles, a plurality of charged magenta particles, and a plurality of charged cyan particles.

23. The electrophoretic display in claim 1, wherein a colloidal solution of the display layer comprises a plurality of charged white particles, a plurality of charged yellow particles, a plurality of charged red particles, and a plurality of charged blue particles.
